(19) United States
(12) Patent Application Publication
(10) Pub. No.: US 2017/0310676 A1
(43) Pub. Date: Oct. 26, 2017

(54) METHOD FOR ACCESSING SWITCH EXTERNAL MEMORY FROM CONTROL PLANE AND DATA PLANE

(71) Applicants: INSTITUTE OF ACOUSTICS, CHINESE ACADEMY OF SCIENCES, Beijing (CN); BEIJING INTELLIX TECHNOLOGIES CO. LTD., Beijing (CN)

(72) Inventors: Lingfang WANG, Beijing (CN); Jinlin WANG, Beijing (CN); Weining QI, Beijing (CN)

(73) Assignees: INSTITUTE OF ACOUSTICS, CHINESE ACADEMY OF SCIENCES, Beijing (CN); BEIJING INTELLIX TECHNOLOGIES CO. LTD., Beijing (CN)

(21) Appl. No.: 15/528,098

(22) PCT Filed: Mar. 12, 2015
(86) PCT No.: PCT/CN2015/074086

§ 371 Date: May 18, 2017

(30) Foreign Application Priority Data
Nov. 19, 2014 (CN) 201410665938.5

(51) Int. Cl. H04L 29/06; H04L 29/08; G06F 13/40; G06F 13/42

(52) U.S. Cl. CPC H04L 63/10; H04L 67/1097; G06F 13/4022; G06F 13/4282

(57) ABSTRACT

The present invention relates to a method for accessing a switch external memory from a control plane and a data plane. A control module issues information about an authorized entity and an authorized operation to a switch, and the switch receives and stores the authorized information; the switch receives a file I/O operation instruction and determines whether an operation entity has the authority of the file I/O operation instruction according to the instruction and the authorized information; and for the operation entity having the authority of the file I/O operation instruction, the switch extracts an instruction index and parameter from the file I/O operation instruction and executes a file I/O operation.

### CROSS REFERENCE TO RELATED APPLICATIONS

This application is the national phase entry of International Application No. PCT/CN2015/074086, filed on Mar. 12, 2015, which is based upon and claims priority to Chinese Patent Application No. 201410665938.5 filed on Nov. 19, 2014, the entire contents of which are incorporated herein by reference.

### TECHNICAL FIELD

The invention relates to the field of network technique, and particularly to a method for accessing a switch external memory from a control plane and a data plane.

### BACKGROUND OF THE INVENTION

Investigation has been made on a Software Defined Network (SDN) in the network industry since the year of 2008, thus resulting in a new round of extensive innovation. The SDN was initially proposed for the purpose of dealing with network failures or network attacks. In a distributed routing architecture of the internet, if there is a network failure or attack, it may be difficult to start the entire network from a point, and since exchanging of a route is not centrally controlled, the route will converge in a magnitude order of minutes, thus significantly failing to make a rapid response. In view of this, some investigators proposed a view that a central control point issues a control strategy and a hop-by-hop switching device, i.e., the concept of SDN.

With the proposal of the SDN, it is necessary to verify it against a real device/protocol/network/application, thus resulting in OpenFlow of ONF. OpenFlow relates to two entities of a controller and a switch. OpenFlow is a southbound interface of the controller to communicate with the switch, and to pass control information, data, and states, etc. OpenFlow was initially configured to optimize a control process and a data flow path and to enhance management and control in a campus network, an enterprise network, and a data center network. Due to the flexibility thereof in controlling a network, the network investigators make investigation on a future network architecture and protocol using OpenFlow, thus resulting in Protocol Oblivious Forwarding (POF) available from Huawei Corp., and the P4 language led by Nick McKeown in U.S.A. The investigation on OpenFlow may involve three aspects: a controller, a line protocol, and switches, wherein the controller represents a control plane, the switch represents a data plane, and the line protocol represents a bridge between them. OpenFlow is focused on programmability of the network, wherein it was early focused on programmability of the control plane, and now coming to programmability of the data plane.

Programmability of the data plane is focused on the use of computing resources and network resources of the switch without taking efficient storage resources into account. The switch in the prior art fails to address the issue of controlling the storage resources, thus making it impossible to access efficiently the switch external memory from the control plane and the data plane.

### SUMMARY OF THE INVENTION

The objective of the invention is to solve the problem in the prior art of failing to access efficiently a switch external memory from a control plane and a data plane, by providing a method for accessing a switch external memory from a control plane and a data plane.

In order to attain the object above, the invention provides a method for accessing a switch external memory from a control plane and a data plane, comprising:

step 1), issuing, by a control module, information about an authorized entity and an authorized operation to a switch, and receiving and storing, by the switch, the authorized information;

step 2), receiving, by the switch, a file I/O operation instruction, and determining whether an operating entity has an authority of the file I/O operation instruction according to the instruction and the authorized information obtained in the step 1); and

step 3), for the operating entity having the authority of the file I/O operation instruction, extracting, by the switch, an instruction index and parameters from the file I/O operation instruction, and executing a file I/O operation.

In the technical solution above, in the step 1), the information about the authorized entity and the authorized operation is issued to the switch in a list of authorized operations, wherein the list of authorized operations is accomplished by employing a set of file operations defined in POSIX.1.

In the technical solution above, the step 2) further comprises:

extracting, by the switch upon receiving the file I/O operation instruction, the operating entity and the file I/O operation instruction index from the instruction, comparing the information extracted from the instruction with the authorized information stored in the switch in the step 1), judging whether the operating entity has the authority of the file I/O operation instruction, if yes, proceeding to the step 3); otherwise, rejecting the operation, and generating and returning a rejection message to a sender of the file I/O operation instruction.

In the technical solution above, the step 3) further comprises:

extracting, by the switch, the file I/O operation instruction index and the parameters from the received file I/O operation instruction, invoking a corresponding local file I/O operation instruction according to the extracted result, generating a corresponding operation result, and finally encapsulating the operation result into a message, and then returning the message to an invoker.

An advantage of the invention is as follows:

The invention solves the problem in the prior art of failing to access the programmable switch external memory from the control plane and the data plane.

### BRIEF DESCRIPTION OF THE DRAWINGS

FIG. 1 is a schematic diagram of a connection relationship between a controller and a switch (including an external memory);

FIG. 2 is a diagram of a file I/O module within the switch;

FIG. 3 is a flow chart of an access authorization process in a method according to the invention;

FIG. 4 is a flow chart of a file I/O operation control process in a method according to the invention;

FIG. 5 is a flow chart of a file I/O operation execution process in a method according to the invention; and

FIG. 6 is a schematic diagram of a forwarding process at an NDN node.

### DETAILED DESCRIPTION OF THE INVENTION

The invention will be further described below with reference to the drawings.

A method for accessing a switch external memory from a control plane and a data plane according to the invention relates to entities of a control module and a switch. The control module can be a controller or an application, wherein the controller is functionally similar to a controller in OpenFlow, and responsible for access authorization control on the switch external memory, defining an access to the switch external memory in a specific protocol, in addition to the roles of the controller in OpenFlow. The switch is functionally similar to a switch in OpenFlow, is provided with an external memory device, and has a function of implementing access operation to the external memory device, in addition to the roles of the switch in OpenFlow. As illustrated in FIG. 1, the control module and the switch communicate with each other in a line protocol.

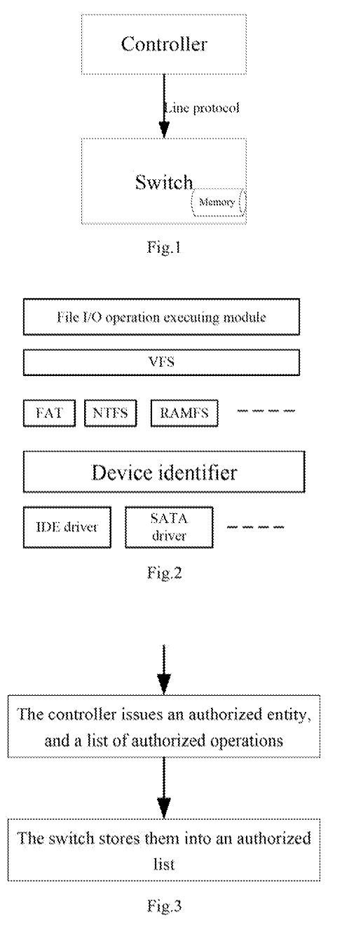

The switch and the external memory device can communicate with each other in a way of bus such as IDE, SATA, fibre channel, SCSI. As illustrated in FIG. 2, a local access can be implemented in an operating system of the switch using a VFS/file system/device identification/device driver, or by mapping the VFS directly to the device driver. Communication between the switch and the external memory device is irrelevant to the spirit of the invention, so a detailed description thereof will be omitted here.

A method for accessing a switch external memory from a control plane and a data plane according to the invention comprises:

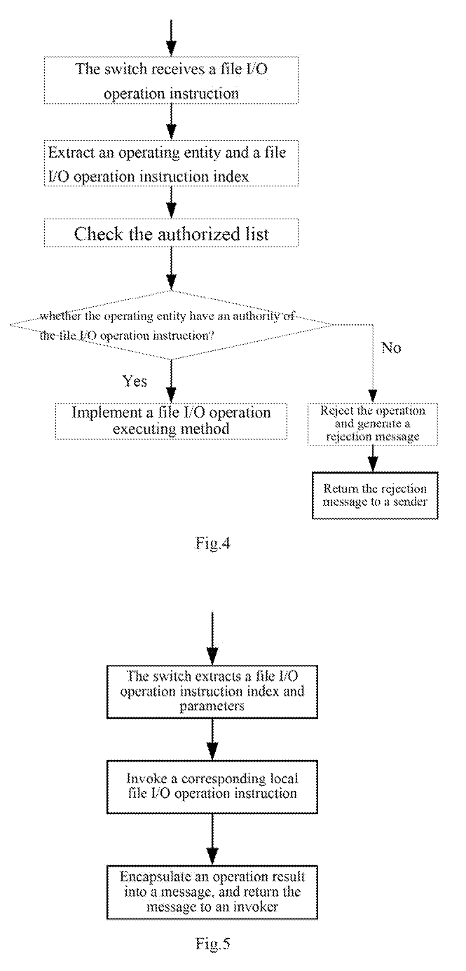

Step 1, referring to FIG. 3, a control module issues information about an authorized entity and an authorized operation to a switch, and the switch receives and stores the authorized information.

The authorized entity as referred to in this step can be a certain application program or protocol performed in the switch, and the authorized operation can be any of a plurality of operations including Read, Write, Delete, and other operations. In an optional implementation, the information about the authorized entity and the authorized operation is issued to the switch in a list of authorized operations. The list of authorized operations can be accomplished by employing a set of file operations defined in POSIX.1, or self-defined file operations, or a subset thereof, and represented as a binary mapping table, wherein a bit of 1 represents Authorized, and a bit of 0 represents Non-authorized, thus greatly reducing the scale of the list of authorized operations issued by the control module to the switch. The list of authorized operations can alternatively be a text string at the cost of an increased overhead.

Step 2), referring to FIG. 4, the switch receives a file I/O operation instruction, extracts an operating entity and a file I/O operation instruction index (which is a binary mapping code corresponding to the instruction) from the instruction, compares the information extracted from the instruction with the authorized information stored in the switch in the step 1), judges whether the operating entity has the authority of the file I/O operation instruction, and if yes, the switch will proceed to the next step; otherwise, the switch will reject the operation, and generate and return a rejection message to a sender of the file I/O operation instruction.

Step 3), referring to FIG. 5, the switch extracts the file I/O operation instruction index and parameters from the received file I/O operation instruction, invokes a corresponding local file I/O operation instruction according to the extracted result, generates a corresponding operation result, and finally encapsulates the operation result into a message, and then returns the message to an invoker.

For the sake of convenient understanding, the method according to the invention will be described below in details with reference to a particular example thereof.

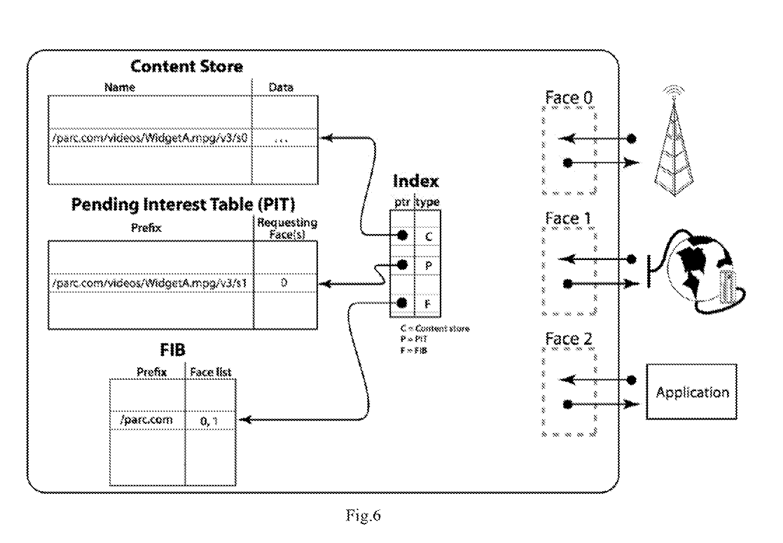

As illustrated in FIG. 6, in an NDN node in a named data networking, a Data component in a Content Store table needs to be supported by an external memory device, and it is assumed that the data are stored in a file. In this scenario, it is assumed that an NDN protocol is developed by employing an SDN method, and an Ethernet message is applied in the switch, wherein the type field Ethertype corresponding to the NDN in the Ethernet message is 0x8099 (only by way of an example). The method according to the invention will be described below with reference to this scenario.

The control module authorizes the access-authorized entity (i.e., Ethertype=0x8099) to have reading, writing, and deleting operations for a file in a directory thereof (other operations are prohibited by default) (it is assumed that there are 32 bits in an authorized mapping table, wherein each bit corresponds to one of the operations, and these three operations correspond to three bits in the uppermost byte, then the bitmap will correspond to hexadecimal 0xe0000000). The control module passes authorization information “Ethertype=0x8099, Permitted Operation=0xe0000000” to the switch in a list of authorized operations over a secured channel, and the switch stores the identifier Ethertype=0x8099 of the authorized entity and a permitted operation code PermittedOperation=0xe0000000.

It is assumed that the switch receives a message of Ethertype=0x8099, i.e., a message of the NDN; and also an action in a mapping action table (a table in OpenFlow in the SDN southbound interface protocol, wherein the table includes field name, value, action, and other information) requires a payload of the message to be written into a local file. The switch receiving a file writing operation extracts an operating entity (i.e., the NDN) and a file writing operation instruction index, refers to the authorized list, and determines that the file writing operation instruction of the NDN is permitted, then the switch executes a file I/O operation.

The switch extracts the file writing operation instruction index and the payload of the message, invokes a local file writing operation instruction to execute a writing operation, encapsulates an operation result into a message, and returns the message to an action invoker in the mapping action table.

If an action requires a directory creating operation, the switch, when receiving a directory creating operation, extracts an operating entity (i.e., the NDN) and a directory operation instruction index, refers to the authorized list, and determines that the directory creating operation instruction of the NDN is prohibited, then the switch rejects the operation, and generates and returns a rejection message to an action invoker in the mapping action table.

Lastly it shall be noted that the embodiments above are merely intended to illustrate but not limit the technical solution according to the invention. Although the invention has been described in details with reference to the embodiments thereof, those ordinarily skilled in the art shall appreciate that any modifications or equivalent substitutions made to the technical solution according to the invention without departing from the spirit and scope of the invention shall fall into the scope of the appended claims.

1. A method for accessing a switch external memory from a control plane and a data plane, comprising:
step 1), issuing an authorized information about an authorized entity and an authorized operation to a switch through a control module, and receiving and storing the authorized information by the switch;
step 2), receiving, by the switch, a file I/O operation instruction, and determining whether an operating entity has an authority of the file I/O operation instruction according to the file I/O operation instruction and the authorized information obtained in the step 1); and
step 3), for the operating entity having the authority of the file I/O operation instruction, extracting, by the switch, an instruction index and parameters from the file I/O operation instruction, and executing a file I/O operation.

2. The method for accessing the switch external memory from the control plane and a data plane according to claim 1, wherein in the step 1), the information about the authorized entity and the authorized operation is issued to the switch in a list of authorized operations; wherein the list of authorized operations is accomplished by employing a set of file operations defined in POSIX.1.

3. The method for accessing the switch external memory from the control plane and a data plane according to claim 1, wherein the step 2) further comprises:
extracting, by the switch upon reception of the file I/O operation instruction, the operating entity and the file I/O operation instruction index from the instruction.
comparing the information extracted from the instruction with the authorized information stored in the switch in the step 1),
judging whether the operating entity has the authority of the file I/O operation instruction, if yes, proceeding to the step 3); otherwise, rejecting the operation, and generating and returning a rejection message to a sender of the file I/O operation instruction.

4. The method for accessing the switch external memory from the control plane and a data plane according to claim 1, wherein the step 3) further comprises: extracting by the switch, the file I/O operation instruction index and the parameters from the received file I/O operation instruction, invoking a corresponding local file I/O operation instruction according to the extracted result, generating a corresponding operation result, and finally encapsulating the operation result into a message, and then returning the message to an invoker.
